(19) United States
(12) Patent Application Publication
(10) Pub. No.: US 2011/0012468 A1
(43) Pub. Date: Jan. 20, 2011

(54) Stator and Radial Gap Motors Including The Stator

(76) Inventors: Alex Horng, Kaohsiung (TW); Tso-Kuo Yin, Kaohsiung (TW)

Correspondence Address: KAMRATH & ASSOCIATES P.A., 4825 OLSON MEMORIAL HIGHWAY, SUITE 245, GOLDEN VALLEY, MN, 55422, US

(21) Appl. No.: 12/504,723

(22) Filed: Jul. 17, 2009

(51) Int. Cl. H02K 3/04

(52) U.S. Cl. 310/195

(57) ABSTRACT

A stator for a radial gap motor is formed by winding a plurality of metal wires to form a hollow cylinder having a plurality of poles and a plurality of turns. Two ends of each metal wire are located on the same end of the cylinder and form a plurality of conductive members for electric connection with a circuit board. The stator is simple in structure and easy to manufacture. The stator can be utilized in various radial gap motors, so that the radial gap motors benefit from the advantages of the stator.

### BACKGROUND OF THE INVENTION

1. Field of the Invention

The present invention relates to a stator and radial gap motors including the stator and, more particularly, to a cylindrical stator formed by metal wires only and radial gap motors including the stator.

2. Description of the Related Art

Currently available radial gap motors include outer rotor type and inner rotor type. Outer rotor type motors have advantages of simple structure, good heat dissipation, and low costs, whereas inner rotor type motors have better rotational stability.

FIGS. 1 and 2 show a conventional outer rotor type motor 8 including a base 8 81, a stator 82, and a rotor 83. The base 81 includes a shaft tube 811. The stator 82 is mounted to an outer periphery of the shaft tube 811. The rotor 83 includes a permanent magnet 831 and is rotatably extended through the shaft tube 811. The stator 82 interacts with the permanent magnet 831 to drive the rotor 83 to rotate. More specifically, the stator 82 of the motor 8 includes a plurality of silicon steel plates 821, an upper insulating sleeve 822, a lower insulating sleeve 823, and a coil unit 824. The silicon steel plates 821 are stacked up and engaged with each other as a single member. The upper and lower insulating sleeves 822 and 823 are coupled to two ends of the stacked silicon steel plates 821. The coil unit 824 is wound around the silicon steel plates 821 and the upper and lower insulating sleeves 822 and 823 at predetermined portions.

The silicon steel plates 821 are formed by pressing and then stacked one upon another. Next, the upper and lower insulating sleeves 822 and 823 are respectively coupled to the ends of the stacked silicon steel plates 821 before winding the coil unit 824. The stator 82 has many components and, thus, a complicated structure, resulting in high manufacturing costs and assembling inconvenience. Furthermore, the axial height of the stator 82 is relatively large, such that the overall volume and the overall axial height of the outer rotor type motor 8 can not be effectively reduced. As a result, miniaturization of the outer rotor type motor 8 is almost impossible.

FIGS. 3 and 4 show an inner rotor type motor 9 including a housing 91, a stator 92, a rotor 93, and a permanent magnet 94. The housing 91 is hollow and receives the stator 92. The rotor 93 includes a shaft 931 rotatably received in the housing 91 and extending through the stator 92. The permanent magnet 94 is coupled to the shaft 931 and received in the stator 92. The stator 92 interacts with the permanent magnet 94 to drive the rotor 93 to rotate. The stator 92 of the inner rotor type motor 9 also includes a plurality of silicon steel plates 921, upper and lower insulating sleeves 922 and 923, and a coil unit 924. The stator 92 of the inner rotor type motor 9 is substantially the same as the stator 82 of the outer rotor type motor 8 and, thus, has the same disadvantages including high manufacturing costs, assembling inconvenience, difficulties in reducing the axial height, and low rotational stability.

### SUMMARY OF THE INVENTION

The primary objective of the present invention is to provide a stator for a radial gap motor that is easy to manufacture.

Another objective of the present invention is to provide a stator for a radial gap motor that is simple in structure.

A further objective of the present invention is to provide a stator for a radial gap motor that can be manufactured at low costs due to simple structure and easy manufacturing of the stator.

Still another objective of the present invention is to provide radial gap motors including a stator having the above-mentioned advantages, so that the radial gap motors also benefit from the above-mentioned advantages.

A stator for a radial gap motor according to the preferred teachings of the present invention is formed by winding a plurality of metal wires to form a hollow cylinder having a plurality of poles and a plurality of turns. Two ends of each of the plurality of metal wires are located on the same end of the cylinder and form a plurality of conductive members.

In a first aspect, a radial gap motor of inner rotor type includes a housing. A cylindrical stator is fixed to the inner periphery of the housing and includes a plurality of conductive members on an end thereof. A rotor includes a shaft and a permanent magnet connected to the shaft. The permanent magnet is aligned with the stator with a radial gap formed between the permanent magnet and the stator. A base is engaged with the housing. A compartment is defined by the base and the housing. A circuit board and at least one bearing are received in the compartment. The circuit board is electrically connected to the conductive members. The at least one bearing rotatably supports the shaft of the rotor.

In a second aspect, a radial gap motor of outer rotor type includes a base having a shaft tube receiving at least one bearing. A circuit board is mounted to the base. A rotor includes a shaft rotatably supported by the at least one bearing. The rotor includes a casing, and an annular permanent magnet is mounted to an inner periphery of the casing. A cylindrical stator includes a plurality of conductive members on an end thereof. The stator is fixed to an outer periphery of the shaft tube and aligned with the annular permanent magnet of the rotor with a radial gap formed between the annular permanent magnet and the stator. The conductive members are electrically connected to the circuit board.

The present invention will become clearer in light of the following detailed description of illustrative embodiments of this invention described in connection with the drawings.

### BRIEF DESCRIPTION OF THE DRAWINGS

The illustrative embodiments may best be described by reference to the accompanying drawings where:

FIG. 1 shows a cross sectional view of a conventional outer rotor type motor.

FIG. 2 shows a perspective view of a stator of the motor of FIG. 1.

FIG. 3 shows a cross sectional view of a conventional inner rotor type motor.

FIG. 4 shows a perspective view of a stator of the motor of FIG. 3.

FIG. 5 shows a perspective view of a stator according to the preferred teachings of the present invention.

FIG. 6 shows a cross sectional view of a radial gap motor utilizing the stator of FIG. 5.

FIG. 7 shows a cross sectional view of another radial gap motor utilizing the stator of FIG. 5.

FIG. 8 shows a cross sectional view of a further radial gap motor utilizing the stator of FIG. 5.

FIG. 9 shows a cross sectional view of still another radial gap motor utilizing the stator of FIG. 5.

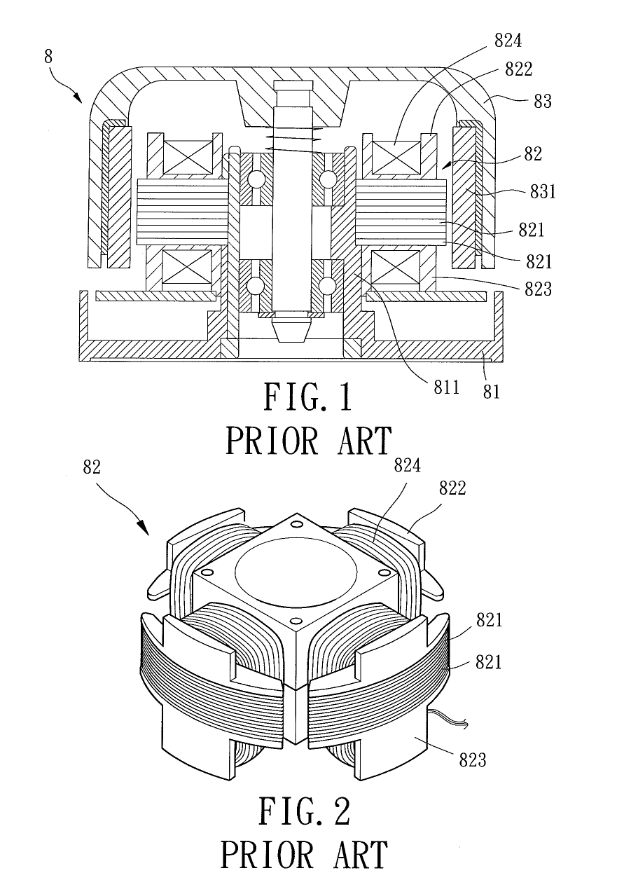

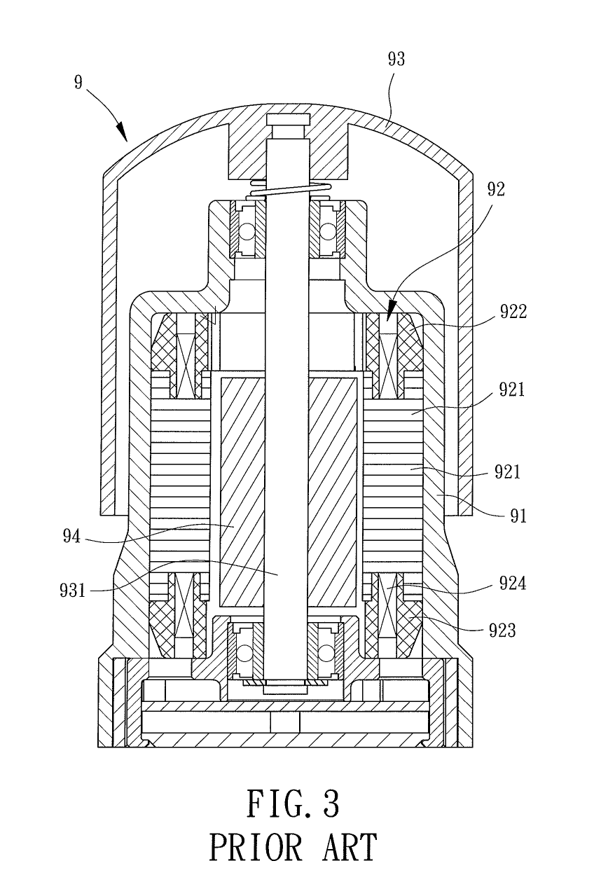

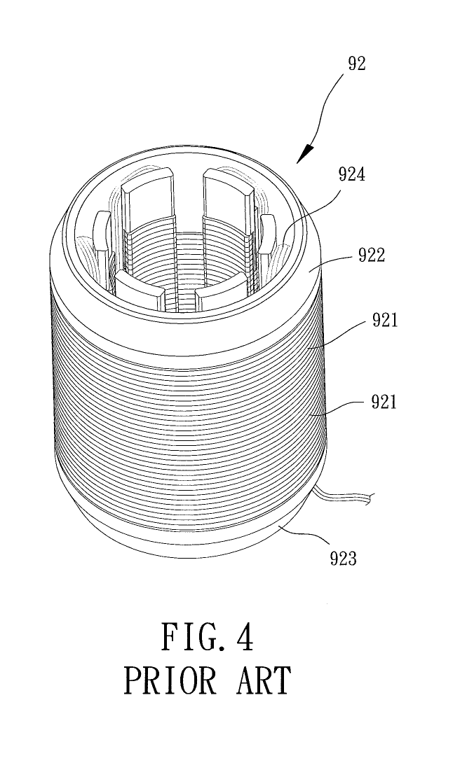

All figures are drawn for ease of explanation of the basic teachings of the present invention only; the extensions of the figures with respect to number, position, relationship, and dimensions of the parts to form the preferred embodiments will be explained or will be within the skill of the art after the following teachings of the present invention have been read and understood. Further, the exact dimensions and dimensional proportions to conform to specific force, weight, strength, and similar requirements will likewise be within the skill of the art after the following teachings of the present invention have been read and understood.

Where used in the various figures of the drawings, the same numerals designate the same or similar parts. Furthermore, when the terms “inner”, “outer”, “end”, “portion”, “axial”, “annular”, and similar terms are used herein, it should be understood that these terms have reference only to the structure shown in the drawings as it would appear to a person viewing the drawings and are utilized only to facilitate describing the invention.

### DETAILED DESCRIPTION OF THE INVENTION

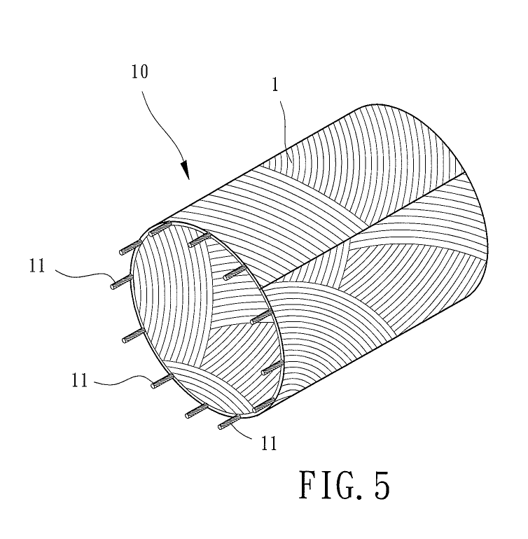

FIG. 5 shows a stator 10 for a radial gap motor according to the preferred teachings of the present invention. The stator 10 is formed by winding a plurality of metal wires 1 to form a hollow cylinder having a plurality of poles and a plurality of turns. The metal wires 1 can be enameled wires or named wires treated with insulating treatment. The metal wires 1 can be arranged to form a plate-like structure and then rolled to form the hollow cylinder. Two ends of each metal wire 1 are located on the same end of the cylinder to form a plurality of conductive members 11. Each conductive member 11 can be formed by winding a single metal wire 1 to include a plurality of layers one overlapped by another. Alternatively, each conductive member 11 can be formed by winding a plurality of metal wires 1. In either case, the conductive members 11 have certain strength. However, the cylinder can include a plurality of rigid pegs or stubs formed on an end thereof, and the metal wires 1 are wound around the rigid pegs or stubs.

The stator 10 can be utilized in various radial gap motors.

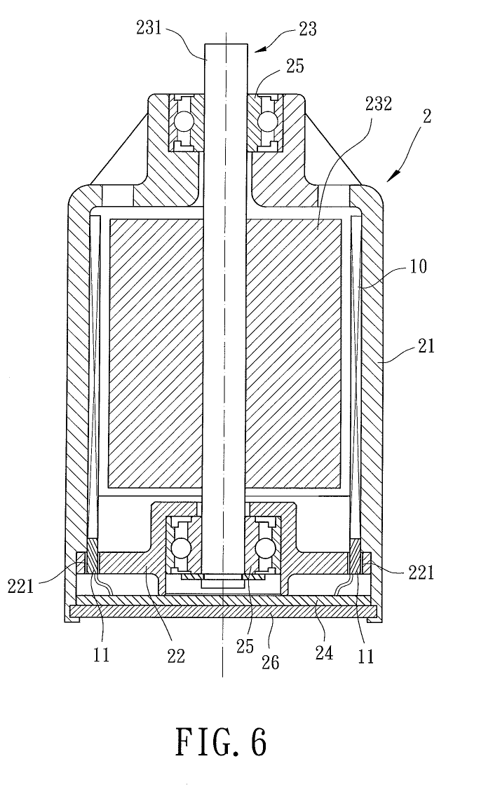

In a first example shown in FIG. 6, the stator 10 is utilized in a radial gap motor 2 of inner rotor type. The radial gap motor 2 includes a housing 21, a base 22, a rotor 23, a circuit board 24, at least one bearing 25, and the stator 10. The housing 21 is engaged with the base 22 to define a compartment receiving the other elements. The rotor 23 includes a shaft 231 rotatably supported by the at least one bearing 25. A permanent magnet 232 is connected to the shaft 231. The circuit board 24 is fixed in the housing 21. In this example, the circuit board 24 is mounted below the base 22 and covered by a cover 26.

The cylindrical stator 10 is fixed to an inner periphery of the housing 21 and aligned with the permanent magnet 232 with a radial gap formed between the stator 10 and the permanent magnet 232. The base 22 includes a plurality of through-holes 221. Each conductive member 11 is extended through one of the through-holes 221 to be electrically connected to the circuit board 24. The conductive members 11 also provide a positioning function for positioning the stator 10. When electric current is introduced into the stator 10, the permanent magnet 232 of the rotor 23 induces with the stator 10 and rotates to output power. The rotor 23 can be utilized as an impeller for driving air currents.

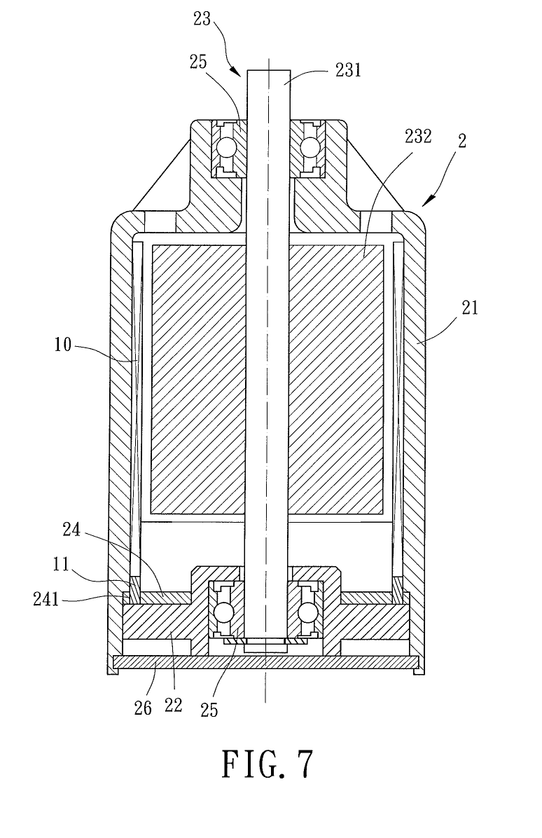

In a second example shown in FIG. 7, the stator 10 is utilized in a radial gap motor 2 of inner rotor type. The radial gap motor 2 includes a housing 21, a base 22, a rotor 23, a circuit board 24, at least one bearing 25, and the stator 10. The housing 21 is engaged with the base 22 to define a compartment receiving the other elements. The rotor 23 includes a shaft 231 rotatably supported by the at least one bearing 25. A permanent magnet 232 is connected to the shaft 231. The circuit board 24 is fixed in the compartment defined by the housing 21 and the base 22. In this example, the circuit board 24 is mounted above the base 22, and a cover 26 is mounted to an opening in a bottom of the housing 21.

The cylindrical stator 10 is fixed to an inner periphery of the housing 21 and aligned with the permanent magnet 232 with a radial gap formed between the stator 10 and the permanent magnet 232. The circuit board 24 includes a plurality of electrically conductive holes 241. The conductive members 11 are in direct, electric contact with the electrically conductive holes 241 and, thus, electrically connected to the circuit board 24. The conductive members 11 also provide a positioning function for positioning the stator 10. When electric current is introduced into the stator 10, the permanent magnet 232 of the rotor 23 induces with the stator 10 and rotates to output power. The rotor 23 can be utilized as an impeller for driving air currents.

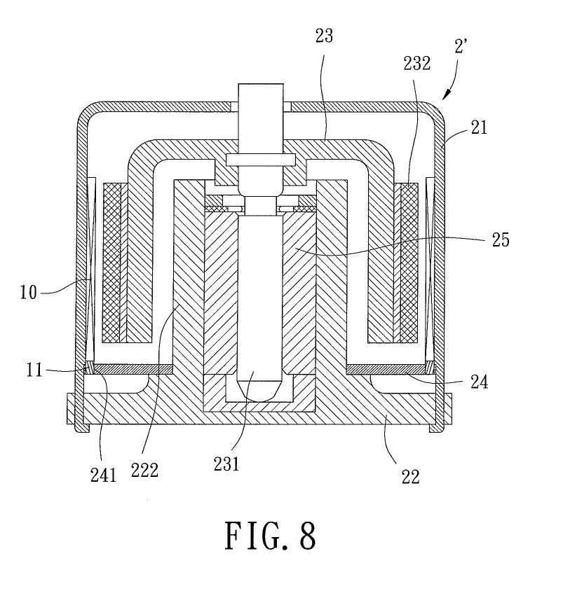

In a third example shown in FIG. 8, the stator 10 is utilized in a radial gap motor 2′ of inner rotor type. The radial gap motor 2′ includes a housing 21, a base 22, a rotor 23, a circuit board 24, at least one bearing 25, and the stator 10. The housing 21 is engaged with the base 22 to define a compartment receiving the other elements. The base 22 includes a shaft tube 222 receiving the at least one bearing 25. The rotor 23 includes a shaft 231 rotatably supported by the at least one bearing 25. A permanent magnet 232 is connected to the shaft 231. The circuit board 24 is fixed in the compartment defined by the housing 21 and the base 22. In this example, the circuit board 24 is mounted around the shaft tube 222.

The cylindrical stator 10 is fixed to an inner periphery of the housing 21 and aligned with the permanent magnet 232 with a radial gap formed between the stator 10 and the permanent magnet 232. The circuit board 24 includes a plurality of electrically conductive holes 241. The conductive members 11 are in direct, electric contact with the electrically conductive holes 241 and, thus, electrically connected to the circuit board 24. The conductive members 11 also provide a positioning function for positioning the stator 10. When electric current is introduced into the stator 10, the permanent magnet 232 of the rotor 23 induces with the stator 10 and rotates to output power.

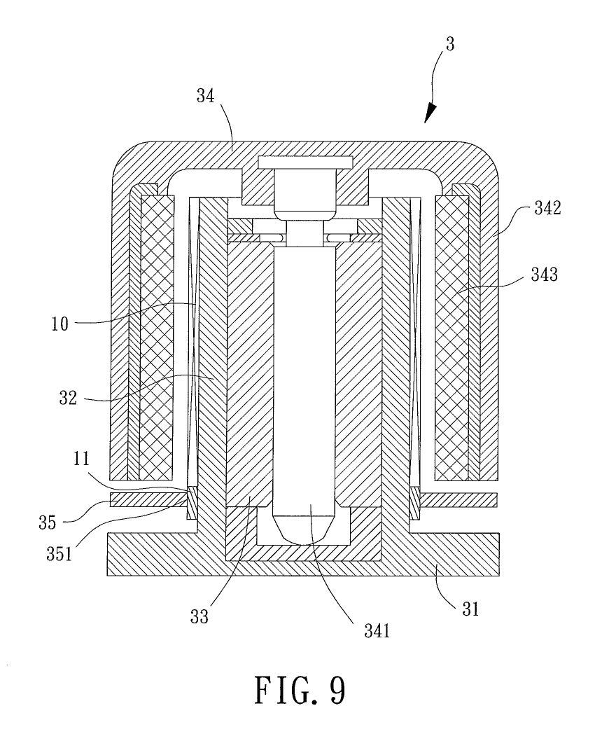

In a fourth example shown in FIG. 9, the stator 10 is utilized in a radial gap motor 3 of an outer rotor type. The radial gap motor 3 includes a base 31, at least one bearing 33, a rotor 34, a circuit board 35, and the stator 10. The base 31 includes a shaft tube 32 receiving the at least one bearing 33 for rotatably supporting a shaft 341 of the rotor 34. The bearing 33 can be a ball bearing or a self-lubricating bearing. The rotor 34 includes a casing 342 and an annular permanent magnet 343 mounted to an inner periphery of the casing 342. The circuit board 35 is mounted around the shaft tube 32 and includes a plurality of electrically conductive holes 351.

The cylindrical stator 10 is fixed to the shaft tube 32 and aligned with the annular permanent magnet 343 with a radial gap formed between the stator 10 and the annular permanent magnet 343. The conductive members 11 are in direct, electric contact with the electrically conductive holes 351 and, thus, electrically connected to the circuit board 35. The conductive members 11 also provide a positioning function for positioning the stator 10. When electric current is introduced into the stator 10, the annular permanent magnet 343 of the rotor 34 induces with the stator 10 and rotates to output power. The rotor 34, when provided with blades, can be utilized to drive air currents.

The stator 10 according to the preferred teachings of the present invention is easy to manufacture, for the stator 10 is formed by simply winding a plurality of metal wires 1. Furthermore, the stator 10 according to the preferred teachings of the present invention is simple in structure, for the stator 10 does not include the silicon steel plates and insulating sleeves required in conventional stators. Thus, the stator 10 according to the preferred teachings of the present invention can be manufactured at low costs, for the stator 10 is easy to manufacture and simple in structure.

Furthermore, the conductive members 11 of the stator 10 according to the preferred teachings of the present invention can be in direct, electrical contact with the electrically conductive holes 241, 351 of the circuit board 24, 35, allowing convenient assembly of the stator 10 according to the preferred teachings of the present invention.

Further, the stator 10 according to the preferred teachings of the present invention can be utilized in various radial gap motors, so that the radial gap motors also benefit from the advantages of the stator 10 according to the preferred teachings of the present invention.

Thus since the invention disclosed herein may be embodied in other specific forms without departing from the spirit or general characteristics thereof, some of which forms have been indicated, the embodiments described herein are to be considered in all respects illustrative and not restrictive. The scope of the invention is to be indicated by the appended claims, rather than by the foregoing description, and all changes which come within the meaning and range of equivalency of the claims are intended to be embraced therein.

What is claimed is:

1. A stator for a radial gap motor formed by winding a plurality of metal wires to form a hollow cylinder having a plurality of poles and a plurality of turns, with each of the plurality of metal wires having two ends, and with the two ends of each of the plurality of metal wires located on a same end of the cylinder and forming a plurality of conductive members.

2. The stator as claimed in claim 1, with each of the plurality of conductive members being formed by winding the plurality of metal wires.

3. The stator as claimed in claim 1, with the end of the cylinder including a plurality of pegs or stubs, and with the plurality of conductive members wound around the plurality of rigid pegs or stubs.

4. A radial gap motor comprising:
a housing having an inner periphery;
a cylindrical stator including a plurality of conductive members on an end thereof, with the stator fixed to the inner periphery of the housing;
a rotor including a shaft and a permanent magnet connected to the shaft, with the permanent magnet aligned with the stator, with a radial gap formed between the permanent magnet and the stator;
a base engaged with the housing, with a compartment defined by the base and the housing, with a circuit board and at least one bearing received in the compartment, with the circuit board electrically connected to the plurality of conductive members, and with said at least one bearing rotatably supporting the shaft of the rotor.

5. The radial gap motor as claimed in claim 4, with the circuit board including a plurality of electrically conductive holes, and with the plurality of conductive members in direct, electric contact with the plurality of electrically conductive holes.

6. A radial gap motor comprising:
a base including a shaft tube receiving at least one bearing, with the shaft tube including an outer periphery, with a circuit board mounted to the base;
a rotor including a shaft rotatably supported by said at least one bearing, with the rotor including a casing having an inner periphery, with an annular permanent magnet mounted to the inner periphery of the casing; and
a cylindrical stator including a plurality of conductive members on an end thereof, with the stator fixed to the outer periphery of the shaft tube and aligned with the annular permanent magnet of the rotor, with a radial gap formed between the annular permanent magnet and the stator, and with the plurality of conductive members electrically connected to the circuit board.

7. The radial gap motor as claimed in claim 6, with the circuit board including a plurality of electrically conductive holes, and with the plurality of conductive members in direct, electric contact with the plurality of electrically conductive holes.
